(19) United States
(12) Patent Application Publication
(10) Pub. No.: US 2005/0016633 A1
(43) Pub. Date: Jan. 27, 2005

(54) Method of manufacturing soft magnetic articles

(75) Inventors: Hirokazu Kugai, Itami-shi (JP); Haruhisa Toyoda, Itami-shi (JP); Naoto Igarashi, Itami-shi (JP); Kazuhiro Hirose, Itami-shi (JP); Takao Nishioka, Itami-shi (JP); Akihiko Ikegaya, Itami-shi (JP); Ryosuke Hata, Osaka (JP); Hitoshi Oyama, Osaka (JP); Kenichi Sato, Osaka (JP); Kazuhiko Hayashi, Osaka (JP); Masayuki Hirose, Osaka (JP); koji Muranaka, Osaka (JP)

Correspondence Address: McDERMOTT, WILL & EMERY, 600 13th Street, N.W., Washington, DC, 20005-3096, US

(73) Assignee: SUMITOMO ELECTRIC INDUSTRIES LTD.

(21) Appl. No.: 10/893,965

(22) Filed: Jul. 20, 2004

(30) Foreign Application Priority Data
Jul. 24, 2003 (JP) 279234/2003
Oct. 8, 2003 (JP) 349351/2003

(51) Int. Cl. H01F 1/03

(52) U.S. Cl. 148/105

(57) ABSTRACT

The method of manufacturing soft magnetic articles comprises a step of preparing a melt solution containing soft magnetic materials and a step of forming soft magnetic particles from the melt solution in a magnetic field by an atomization rapid solidification method.

### BACKGROUND OF THE INVENTION

1. Field of the Invention

The present invention relates to a method of manufacturing soft magnetic articles.

2. Description of the Background Art

Conventionally, electric and electronic parts such as motors, voltage converters, transformers, noise filters, and choke coils are manufactured using soft magnetic materials. For example, the electric and electronic parts can be manufactured by press-forming soft magnetic powders containing iron as a main component so as to form a molded body, and performing appropriate processing on the molded body.

Recently, however, there has been demand for performing more precise control with lower consumption of electric power in order to increase the densities of the electric and electronic parts and to reduce their sizes. In order to meet such demand, it is necessary to reduce the hysteresis loss of soft magnetic articles used for the electric and electronic parts, that is, to increase the magnetic permeability and to reduce the coercive force of the soft magnetic articles. A high frequency compacted magnetic powder core in which the hysteresis loss is reduced and a method of manufacturing the same are disclosed in Japanese Unexamined Patent Application Publication No. 8-167518.

In the method of manufacturing the high frequency compacted magnetic powder core disclosed in the Japanese Unexamined Patent Application Publication No. 8-167518, a magnetic field of 1 T (Tesla) is generated by magnetic field-generating coils, and shape-anisotropic soft magnetic powders consisting of iron as a main component are press-formed in the magnetic field.

However, as compared with a silicon steel plate or ferrite, soft magnetic powders including iron as a main component have innately smaller magnetic permeability and larger coercive force. Therefore, it is not currently possible to sufficiently reduce the hysteresis loss even by the high frequency compacted magnetic powder core and the method of manufacturing the same disclosed in the Japanese Unexamined Patent Application Publication No. 8-167518.

### SUMMARY OF THE INVENTION

Therefore, in order to solve the above-mentioned problems, it is an object of the present invention to provide a method of manufacturing soft magnetic articles in which the hysteresis loss is sufficiently reduced.

### BRIEF DESCRIPTION OF THE DRAWINGS

FIG. 1 is a sectional view illustrating an atomizing device used for a method of manufacturing soft magnetic articles according to a first embodiment of the present invention.

FIG. 2 is an enlarged schematic diagram illustrating soft magnetic powders formed using the atomizing device in FIG. 1.

FIG. 3 is a graph illustrating magnetization curves of a single crystal of Fe.

FIG. 4 is a sectional view illustrating a heat treatment device used for manufacturing soft magnetic articles according to the method of a second embodiment of the present invention.

FIG. 5 is a sectional view illustrating a heat treatment device used for manufacturing soft magnetic articles according to the method of a third embodiment of the present invention.

### DETAILED DESCRIPTION OF THE INVENTION

The inventors of the present invention discovered that it is possible to increase the magnetic permeability of soft magnetic materials and to reduce the coercive force of the soft magnetic materials by the following methods.

1. The respective crystals in soft magnetic particles are oriented in the direction of an easy axis of magnetization.

2. The grain boundaries in the soft magnetic particles are reduced. That is, the number of crystals is reduced by increasing the size of the crystals in the soft magnetic particles. Final object is that the soft magnetic particles are made of single-crystals.

3. The proportion of the impurities in the soft magnetic particles is reduced in order to increase the purity of the soft magnetic particles.

4. Distortions (dislocations and defects) in the soft magnetic particles are reduced.

On the basis of such discovery, the inventors have completed a manufacturing method of the present invention for soft magnetic articles. The term “soft magnetic articles” as used in the present specification includes not only soft magnetic particles and soft magnetic molded bodies obtained by press-forming soft magnetic particles, but also extruded articles produced from the soft magnetic molded bodies by extrusion-processing or the like.

A method of manufacturing soft magnetic articles according to an aspect of the present invention includes a step of preparing a melt solution containing soft magnetic materials and a step of forming soft magnetic particles from the melt solution in the magnetic field by an atomization rapid solidification method.

According to the method comprising the above-mentioned steps for manufacturing soft magnetic articles, respective crystals constituting soft magnetic particles tend to be magnetized in the direction of an easy axis of magnetization so as to be in a stable state when a magnetic field is applied in the step of crystallizing the soft magnetic particles. By using such magnetocrystalline anisotropy, it is possible to orient the respective crystals in the soft magnetic particles in the direction of the easy axis of magnetization. Also, since the number of domains in the soft magnetic particles is reduced due to the influence of the magnetic field, it is possible to reduce the grain boundaries. Furthermore, it is possible to improve the purity of the soft magnetic particles since impurities are deposited to the outside by the influence of the magnetic field during crystallization of the soft magnetic particles Also, since the crystal lattice orientation is optimized due to the influence of the magnetic field, the dislocation and stress distortion can be reduced. Therefore, according to the present invention, it is possible to provide the soft magnetic articles in which the hysteresis loss is sufficiently reduced.

The step of forming the soft magnetic particles preferably includes a process of forming the soft magnetic particles in a magnetic field exceeding 8.0×10⁵ (A/m According to the method having such structure as described above for manufacturing soft magnetic articles, it is possible to increase the influence of the magnetic field by applying the magnetic field exceeding 8.0×10⁵ (A/m), that is, 10 kOe (kilo oersted). Consequently, soft magnetic articles in which the hysteresis loss is further reduced can be provided.

A method of manufacturing soft magnetic articles according to another aspect of the present invention includes the steps of forming soft magnetic particles and performing heat treatment on the soft magnetic particles in a magnetic field.

According to the method having the above-mentioned structure for manufacturing soft magnetic articles, it is possible to orient the respective crystals in the soft magnetic particles in the direction of an easy axis of magnetization by using the magnetocrystalline anisotropy. Also, since the number of domains in the soft magnetic particles is reduced due to the influence of the magnetic field, it is possible to reduce the grain boundaries. Also, it is possible to improve the purity of the soft magnetic particles since the impurities are deposited to the outside by the influence of the magnetic field when the soft magnetic particles are re-crystallized. Furthermore, since the crystal lattice orientation is optimized due to the influence of the magnetic field, it is possible to reduce the dislocation and the stress distortion. Therefore, according to the present invention, it is possible to provide the soft magnetic articles in which the hysteresis loss is sufficiently reduced.

The step of performing the heat treatment on the soft magnetic particles preferably includes heat-treating the soft magnetic particles in a magnetic field exceeding 8.0×10⁵ (A/m). According to the method having the above-mentioned structure for manufacturing soft magnetic articles, it is possible to increase the influence of the magnetic field by applying the magnetic field exceeding 10 (kOe). Therefore, it is possible to provide the soft magnetic articles in which the hysteresis loss is sufficiently reduced.

A method of manufacturing soft magnetic articles according to another aspect of the present invention comprises the steps of forming a molded body by press-forming soft magnetic particles and performing heat treatment on the molded body in a magnetic field.

According to the method having the above-mentioned steps for manufacturing soft magnetic articles, the respective crystals in the soft magnetic particles can be oriented in the direction of an easy axis of magnetization by using the magnetocrystalline anisotropy. Also, since the number of domains is in the soft magnetic particles is reduced due to the influence of the magnetic field, it is possible to reduce the grain boundaries. Also, since the impurities are deposited to the outside due to the influence of the magnetic field when the soft magnetic particles are re-crystallized, it is possible to improve the purity of the soft magnetic particles. Furthermore, since the crystal lattice orientation is optimized due to the influence of the magnetic field, it is possible to reduce the dislocation and the stress distortion. Therefore, according to the present invention, it is possible to provide the soft magnetic articles in which the hysteresis loss is sufficiently reduced.

The step of performing heat treatment on a molded body preferably includes a process of heat-treating the mold in a magnetic field exceeding 8.0×10⁵ (A/m). According to the method having the above-mentioned steps for manufacturing the soft magnetic articles, it is possible to increase the influence of the magnetic field by applying the magnetic field exceeding 10 (kOe). Consequently, the soft magnetic articles in which the hysteresis loss is further reduced can be provided.

The step of performing the heat treatment preferably includes a process of performing a heat treatment at a temperature higher than the re-crystallization temperature of the soft magnetic particles. According to the method having the above-mentioned steps for manufacturing soft magnetic articles, it is possible to heat to an extent that crystals can easily be oriented.

Preferably, the magnetic field is formed with current flowing in a superconducting coil. By including such step in the method of manufacturing soft magnetic articles, a large magnetic field can easily be formed.

Preferably, the superconducting coil consists of a high temperature superconductor made of oxide materials. The term “high temperature superconductor” means a superconductor that exhibits superconductivity at a relatively high temperature such as 30 K or more. According to the method having such structure as mentioned above for manufacturing the soft magnetic articles, since the cooling device of the superconducting coil is simple, it is possible to reduce the manufacturing cost of the soft magnetic articles.

The soft magnetic particles preferably includes iron as the main component. Here, the soft magnetic particles include iron of 90 atomic % or more. According to the method having such structure as mentioned above for manufacturing the soft magnetic articles, it is possible to obtain soft magnetic articles having a high magnetic flux density. Thus, the sizes of the electric and electronic parts using such soft magnetic articles can be reduced as compared with the case in which ferrite materials are used.

In addition, preferably an insulating film is formed so as to surround the surface of a soft magnetic particle. With such structure of the manufacturing method for the soft magnetic articles, since the insulation between the soft magnetic particles is increased, it is possible to reduce the loss caused by eddy current that flows between the soft magnetic particles. In this case, preferably the process of performing heat treatment on soft magnetic particles or molded bodies is accomplished at a temperature lower than the heat resistant temperature of the insulating film, thereby preventing the insulating characteristics of the insulating film from being deteriorated by the heat treatment process.

In the case that the insulating film is made of non-magnetic articles, it can be expected to improve the magnetic characteristics by applying the magnetic field larger than 10 (kOe). Also, the insulating film is preferably made of heat resistant materials that keep the insulating characteristic at a temperature no less than the re-crystallization temperature of the soft magnetic particles (in the case of the iron, about 400° C.). Such materials are oxide materials, such as SiO₂, Al₂O₃, TiO₂, or ZrO₂, for example.

The term “molded bodies” as used herein includes those available immediately after press-forming and those of product-shape formed by a cutting process following the press-forming, for example. It is possible to prepare a plurality of molded bodies and to assemble them in a direction along the magnetic circuit of a product, thereby producing the product.

As mentioned above, according to the present invention, it is possible to provide a method of manufacturing the soft magnetic articles in which the hysteresis loss is sufficiently reduced.

Embodiments of the present invention will now be described with reference to the drawings.

### FIRST EMBODIMENT

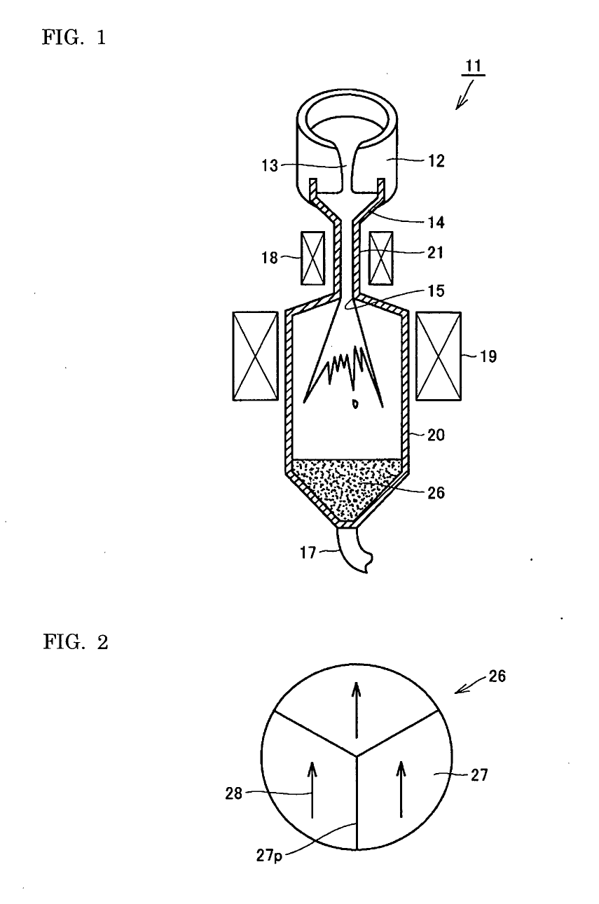

FIG. 1 is a sectional view illustrating an atomizing device used for a method of manufacturing soft magnetic articles according to a first embodiment of the present invention. As shown in FIG. 1, the atomizing device 11 includes a vacuum induction furnace 12, a funnel 14 provided at a lower part of the vacuum induction furnace 12, a spray tower 20, a melt solution inlet pipe 21 for connecting the funnel 14 to the spray tower 20, and superconducting coils 18 and 19 provided around the melt solution inlet pipe 21 and the spray tower 20, respectively. The vacuum induction furnace 12 is surrounded by a melting chamber (not shown) connected to a vacuum pump. A spray nozzle 15 is formed in a portion where the melt solution inlet pipe 21 is connected to the spray tower 20. A powder recovering pipe 17 is connected to the bottom of the spray tower 20.

A method of forming soft magnetic powders using the atomizing device 11 in FIG. 1 will now be described below. First, a raw material lump, for example an iron lump, to be processed into a material of soft magnetic powders is put in the vacuum induction furnace 12. A high frequency power supply is applied to the vacuum induction furnace 12 As a result, the material lump in the vacuum induction furnace 12 is melt to be a melt solution 13. The vacuum induction furnace 12 is kept not necessarily at a vacuum atmosphere, but it may be filled with an inert gas.

Next, a magnetic field is applied to the interior of the melt solution inlet pipe 21 and the spray tower 20 by flowing an electrical current to the superconducting coils 18 and 19. At this time, the applied magnetic field is preferably larger than 10 (kOe). While the magnetic field is applied, the melt solution 13 in the vacuum induction furnace 12 is supplied to the pouring 14. The melt solution 13 passes through the melt solution inlet pipe 21 to which the magnetic field is applied, and is sprayed from the spray nozzle 15 to the inside of the spray tower 20. The melt solution 13 is rapidly cooled, while being sprayed, in the spray tower 20 to which the magnetic field is applied. As a result, soft magnetic powders 26 are formed; and, finally, the soft magnetic powders 26 are recovered through the powder recovering pipe 17.

FIG. 2 is an enlarged schematic diagram illustrating the soft magnetic powders formed using the atomizing device in FIG. 1. Referring to FIG. 2, the soft magnetic powders 26 are composed of a plurality of crystals 27 partitioned by grain boundaries 27p. Although FIG. 2 simply illustrates three crystals 27, the number of crystals 27 is not limited thereto. The respective crystals 27 are oriented in the direction of a magnetization easy axis 28. The melt solution 13 in FIG. 1 is cooled after being fed into the pouring 14 so that crystallization occurs in the melt solution 13. The magnetic field is applied to the melt solution 13 in which the crystallization occurs, and thus the respective formed crystals 27 are oriented in the direction of the magnetization easy axis 28. The principle in which the soft magnetic powders 26 are oriented in the direction of the magnetization easy axis 28 will now be described.

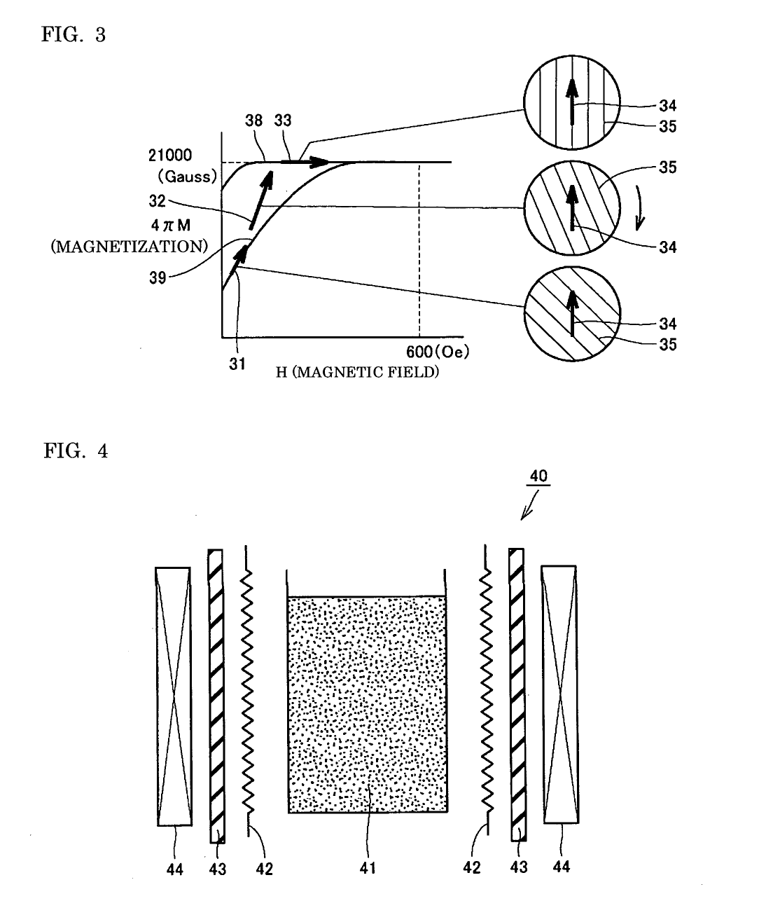

FIG. 3 is a graph illustrating magnetization curves of a single crystal of Fe. Referring to FIG. 3, the vertical axis represents 4π×M (magnetization) and the horizontal axis represents H (magnetic field). A curve 38 denotes a magnetization curve in the direction <100> of a magnetization easy axis. A curve 39 denotes a magnetization curve in the direction <111> of a hard axis of magnetization. When the two curves are compared with each other, it is noted that magnetization can be performed with less energy in the direction <100> and the difference in energy is represented by a region between the curve 38 and the curve 39.

If the magnetic field is applied to the direction <101> (the direction of a magnetic moment marked with an arrow 34) by the superconducting coils, then, at an initial stage the soft magnetic powders are magnetized along the magnetization curve in the direction marked with an arrow 31. Shortly thereafter, the soft magnetic powders begin to rotate in the direction <100> (the direction along a line segment 35) so as to be in a stable state and thus magnetized in the direction marked with an arrow 32. The soft magnetic powders stop rotating when the direction of the magnetic moment coincides with the direction <100>, and thereafter are magnetized along a magnetization curve in the direction marked with an arrow 33. As a result, the soft magnetic powders are oriented in the direction <100> of the magnetization easy axis.

Referring to FIG. 2, as a result of forming the soft magnetic powders in a state where the magnetic field is applied, it is possible to reduce the number of crystals 27 in the soft magnetic powders 26. In this case, it is possible to reduce the grain boundaries 27p that disturbs magnetization. Also, as a result of applying the magnetic field, the purity of the soft magnetic particles in the soft magnetic powders 26 can be improved, and the dislocation and the stress distortion can be reduced.

The method of manufacturing soft magnetic articles according to the first embodiment of the present invention includes a process of preparing the melt solution 13 containing soft magnetic materials and a process of forming the soft magnetic powders 26 as the soft magnetic particles from the melt solution in the magnetic field by the atomization rapid solidification method.

According to the method having the above-mentioned structure for manufacturing a soft magnetic article, it is possible to optimize the magnetic characteristics (i.e., to increase the magnetic permeability and to reduce the coercive force) at the stage of soft magnetic powders that are the materials of a soft magnetic molded body. Therefore, by using the soft magnetic powders it is possible to manufacture electric and electronic parts in which the hysteresis loss is sufficiently reduced.

In the present embodiment, the superconducting coils 18 and 19 are provided around the melt solution inlet pipe 21 and the spray tower 20, respectively. However, a superconducting coil may be provided in either one of the melt solution inlet pipe 21 and the spray tower 20. Means for applying the magnetic field are not restricted to the superconducting coils and common coils may be used. The atomizing device 11 may use either a water atomizing method or gas atomizing method.

In the case where the soft magnetic powders 26 are formed as flat-shaped powders by spraying the melt solution 13 from the spray nozzle 15, the optimization of the magnetic characteristics can be more easily achieved since the easy axis of magnetization can be aligned in the longer dimension of the soft magnetic powder 26.

### SECOND EMBODIMENT

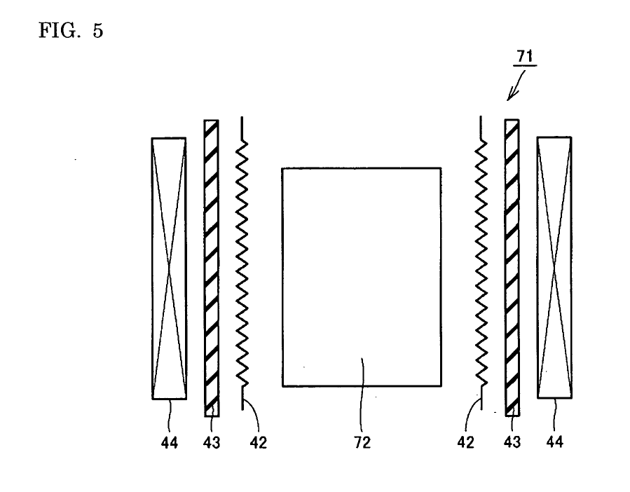

FIG. 4 is a sectional view illustrating a heat treatment device used in the method of manufacturing the soft magnetic materials according to a second embodiment of the present invention. Referring to FIG. 4, a heat treatment device 40 includes a heater 42 provided so as to surround soft magnetic powders 41 in a container, a superconducting coil 44 provided outside the heater 42, an insulating member 43 interposed between the heater 42 and the superconducting coil 44.

A method of performing the heat treatment on the soft magnetic powders using the heat treatment device 40 in FIG. 4 will now be described below. First, the soft magnetic powders 41 such as iron powders are manufactured by the atomizing method. An insulating film may be formed so as to cover the surface of a particle of soft magnetic powders 41. Subsequently, the obtained soft magnetic powders 41 are put in the heat treatment device 40. A magnetic field is applied to the soft magnetic powders 41 by introducing an electrical current to the superconducting coil 44. At this time, the applied magnetic field is preferably larger than 10 (kOe).

Next, in a state where the magnetic field is applied, the heater 42 is electrically powered on and the heat treatment is performed on the soft magnetic powders 41. The soft magnetic powders 41 are heated to a temperature that is higher than the re-crystallization temperature, and subsequently re-crystallization occurs inside the soft magnetic powders 41. Since the magnetic field is applied to the soft magnetic powders 41 in which the re-crystallization takes place, the respective formed crystals are oriented in the direction of the magnetization easy axis.

As a result of applying the magnetic field, it is possible to reduce the number of crystals in the soft magnetic powders 41. Therefore, it is possible to reduce the grain boundaries that disturb the magnetization. Also, as a result of applying the magnetic field, the purity of the soft magnetic particles in the soft magnetic powders 41 can be increased and the dislocation and the stress distortion can be reduced.

The method of manufacturing the soft magnetic articles according to the second embodiment of the present invention includes a process of forming the soft magnetic powders 41 and a process of performing the heat treatment on the soft magnetic powders 41 in the magnetic field. With the method having the above-mentioned structure for manufacturing soft magnetic articles, it is possible to obtain the same effects as those obtained in the first embodiment.

### THIRD EMBODIMENT

FIG. 5 is a sectional view illustrating a heat treatment device used for a method of manufacturing the soft magnetic materials according to a third embodiment of the present invention. Referring to FIG. 5, a heat treatment device 71 has the same structure as the structure of the heat treatment device 40 shown in FIG. 4 except that a soft magnetic molded body 72 is positioned at a part surrounded by the heater 42.

A method of performing the heat treatment on the soft magnetic molded body using the heat treatment device 71 of FIG. 5 will now be described below. First, the soft magnetic mold 72 is manufactured by press-forming the prepared soft magnetic powders. Subsequently, the soft magnetic mold 72 is set in a predetermined position in the heat treatment device 71. A magnetic field is applied to the soft magnetic mold 72 by introducing an electrical current to the superconducting coil 44. At this time, the applied magnetic field is preferably larger than 10 (kOe).

Next, in a state where the magnetic field is applied, the heater 42 is electrically powered on and the heat treatment is performed on the soft magnetic mold 72. The soft magnetic mold 72 is heated to a temperature higher than the re-crystallization temperature. Thereafter, re-crystallization occurs inside the soft magnetic powders that constitute the soft magnetic molded body 72. Since the magnetic field is applied to the soft magnetic powders in which the re-crystallization is performed, the respective formed crystals are oriented in the direction of the magnetization easy axis.

As a result of applying the magnetic field, it is possible to reduce the number of crystals in the soft magnetic powders that constitute the soft magnetic mold 72. Therefore, it is possible to reduce the grain boundaries that disturb the magnetization. Also, as a result of applying the magnetic field, the purity in the soft magnetic powders can be improved and the dislocation and the stress distortion can be reduced. In this case, it is possible to obtain a definite effect even when the heat treatment temperature is low.

A method of manufacturing soft magnetic articles according to the third embodiment of the present invention includes a step of forming a soft magnetic molded body 72 by press-forming soft magnetic particles and a step of performing a heat treatment on the soft magnetic molded body 72 in a magnetic field. According to the method having the above-mentioned steps for manufacturing the soft magnetic articles, after press-forming the soft magnetic particles, it is possible to make the magnetic characteristics optimized (to increase the magnetic permeability and to reduce the coercive force). Therefore, by using the soft magnetic molded body 72, it is possible to manufacture electric and electronic parts in which the hysteresis loss is sufficiently reduced.

The first embodiment to the third embodiment of manufacturing methods for soft magnetic articles as described above may be appropriately combined. In this case, it is possible to manufacture electric and electronic parts in which the hysteresis loss is reduced due to synergy effects through combination of the above-mentioned manufacturing methods.

Also, it is possible to obtain the respective predetermined effects by setting the following heat treatment temperatures in the second and third embodiments, respectively. First, when the heat treatment temperature is set to be equal to or more than the melting point (in the case of iron, 1,535° C.), the internal magnetic field at an atomic level becomes mobile, whereby the internal magnetic field can be optimized. When the heat treatment temperature is set to be equal to or higher than the Curie temperature (in the case of iron, 770° C.) of the soft magnetic powders and lower than the melting point of the soft magnetic powders, the soft magnetic powders are paramagnetic. However, a certain effect can be expected by applying a magnetic field. When the heat treatment temperature is equal to or more than the re-crystallization temperature (in the case of iron, about 300° C. to 400° C.) and less than the Curie temperature, the soft magnetic powders are ferromagnetic, and a considerable effect can be achieved by the application of a magnetic field because of the structure of magnetic domain and exchange interaction between spins.

In the event that the Curie temperature of the soft magnetic powders is shifted to higher temperatures by the application of a magnetic field, a predetermined heat treatment can be performed on ferromagnetic soft magnetic powders, even if the heat treatment temperature is set higher than the Curie temperature (in the case of iron, 770° C.). The insulating film covering soft magnetic powders can be prevented from being damaged during the heat treatment if the heat treatment temperature is set equal to or less than the heat resistant temperature of the insulating film.

In order to confirm the effects of the first to third embodiments of the manufacturing method for the soft magnetic articles, the verification was performed under the conditions represented in the following table.

TABLE

| | | Soft | Conditions during application of magnetic field | | | |
|---|---|---|---|---|---|---|
| | | magnetic | Method of applying | Magnetic | | |
| | Process | powders | magnetic field | field | Temperature | Post process |
| Manufactur- | High magnetic field | | Superconducting | 100 kOe | Equal to or | Forming insulating film→ |
| ing of | applied to molten | | magnet | | more than | Pressing at 10 ton/cm²→ |
| soft | iron | | | | 1,535° C. | Performing heat treatment at |
| magnetic | | | | | | 400° C. |
| powders first | High magnetic field applied during | | Superconducting | 100 kOe | | Forming insulating film→ |
| embodiment) | atomization cooling | | magnet | | | Pressing at 10 ton/ cm²→ |
| | | | | | | Performing heat |
| | | | | | | treatment at 400° C. |
| Heat | Heat treatment performed on soft | Iron | Superconducting | 100 kOe | 1,200° C. | Forming insulating film→ |
| treatment | magnetic powders in high magnetic field | powders | magnet | | | Pressing at 10 ton/cm²→ |
| on soft | before press-forming the same (770° C. to | | | | | Performing heat |
| magnetic | 1,535° C.: equal to or more than Curie | | | | | treatment at 400° C. |
| powders | temperature and less than melting point) | | | | | |
| (second | Heat treatment performed on soft | Iron | Superconducting | 100 kOe | 750° C. | Forming insulating film→ |
| embodiment) | magnetic powders in high magnetic field | powders | magnet | | | Pressing at 10 ton/cm²→ |
| | before press-forming the same (less than | | | | | Performing heat |
| | 770° C.: less than Curie temperature) | | | | | treatment at 400° C. |
| | Heat treatment performed on soft | Iron powders | Superconducting | 100 kOe | 400° C. | Pressing at 10 ton/cm²→ |
| | magnetic powders in high magnetic field | coated with | magnet | | | Performing heat treatment at |
| | before press-forming the same (equal to or | insulating | | | | 400° C. |
| | less than heat resistant temperature of | film | | | | |
| | insulating film) | | | | | |
| Heat | Heat treatment performed on soft | Iron powders | Superconducting | 100 kOe | 1,300° C. | |
| treatment | magnetic powders in high magnetic field | | magnet | | | |
| on soft | after press-forming the same (770° C. to | | | | | |
| magnetic | 1,535° C.: equal to or more than Curie | | | | | |
| mold (third | temperature and less than melting point) | | | | | |
| embodiment) | Heat treatment performed on soft | Iron powders | Superconducting | 100 kOe | 700° C. | |
| | magnetic powders in high magnetic field | | magnet | | | |
| | after press-forming the same (less than | | | | | |
| | 770° C.: less than Curie temperature) | | | | | |
| | Heat treatment performed on soft | Iron powders | Superconducting | 100 kOe | 400° C. | |
| | magnetic powders in high magnetic field | coated with | magnet | | | |
| | after press-forming the same (equal to or | insulating | | | | |
| | less than heat resistant temperature of | film | | | | |
| | insulating film) | | | | | |
| Comparative | | Iron powders | None | | | Pressing at 10 ton/cm²→ |
| example | | coated with | | | | Performing heat treatment at |
| | | insulating | | | | 400° C. |
| | | film | | | | |

The soft magnetic molded bodies according to the first to third embodiments of the methods of manufacturing the soft magnetic articles and the soft magnetic molded bodies according to the comparative example were manufactured under the conditions as described in the Table. Next, the magnetic characteristics (the magnetic flux density B100 and the magnetic permeability and the coercive force when the magnetic field of 100 (Oe) is applied) of the manufactured soft magnetic mold were measured. As a result of measuring them, the magnetic flux density B100 and the magnetic permeability of all of the soft magnetic molds according to the first to third embodiments were larger than those of the soft magnetic mold according to the comparative example and the coercive forces of all of the soft magnetic molds according to the first to third embodiments were smaller than those of the soft magnetic mold according to the comparative example. Therefore, it was confirmed that it is possible to sufficiently reduce the hysteresis loss according to the present invention.

While this invention has been particularly described with reference to preferred embodiments thereof, it will be understood by those skilled in the art that various modifications may be made without departing from the spirits and scopes of the invention as defined by the appended claims.

1. A method of manufacturing soft magnetic articles, comprising the steps of:
preparing a melt solution containing soft magnetic materials; and
forming soft magnetic particles from the melt solution in a magnetic field by an atomization rapid solidification method.

2. The method of manufacturing soft magnetic articles according to claim 1, wherein the step of forming the soft magnetic particles comprises forming the soft magnetic particles in a magnetic field larger than 8.0×10⁵ (A/m).

3. A method of manufacturing soft magnetic articles, comprising the steps of
forming soft magnetic particles; and
performing heat treatment on the soft magnetic particles in a magnetic field.

4. The method of manufacturing soft magnetic articles according to claim 3, wherein the step of performing heat treatment on the soft magnetic particles comprises performing heat treatment on the soft magnetic particles in a magnetic field larger than 8.0×10⁵ (A/m).

5. A method of manufacturing soft magnetic articles, comprising the steps of:
press-forming soft magnetic particles to form a mold; and
performing heat treatment on the mold in a magnetic field.

6. The method of manufacturing soft magnetic articles according to claim 5, wherein the step of performing heat treatment on the mold comprises performing heat treatment on the mold in a magnetic field larger than 8.0×10⁵ (A/m).

7. The method of manufacturing soft magnetic articles according to claim 3, wherein the step of performing heat treatment comprises performing heat treatment at a temperature higher than the re-crystallization temperature of the soft magnetic particles.

8. The method of manufacturing soft magnetic articles according to claim 5, wherein the step of performing heat treatment comprises performing heat treatment at a temperature higher than the re-crystallization temperature of the soft magnetic particles.

9. The method of manufacturing soft magnetic articles according to claim 1, wherein a magnetic field is formed by flowing current to superconducting coils.

10. The method of manufacturing soft magnetic articles according to claim 3, wherein a magnetic field is formed by flowing current to superconducting coils.

11. The method of manufacturing soft magnetic articles according to claim 5, wherein a magnetic field is formed by flowing current to superconducting coils.

12. The method of manufacturing soft magnetic articles according to claim 9, wherein the superconducting coils are formed of a high temperature superconductor made of oxide materials.

13. The method of manufacturing soft magnetic articles according to claim 10, wherein the superconducting coils are formed of a high temperature superconductor made of oxide materials.

14. The method of manufacturing soft magnetic articles according to claim 11, wherein the superconducting coils are formed of a high temperature superconductor made of oxide materials.

15. The method of manufacturing soft magnetic articles according to claim 1, wherein the soft magnetic particles contain iron as a main component thereof.

16. The method of manufacturing soft magnetic articles according to claim 3, wherein the soft magnetic particles contain iron as a main component thereof.

17. The method of manufacturing soft magnetic articles according to claim 5, wherein the soft magnetic particles contain iron as a main component thereof.

18. The method of manufacturing soft magnetic articles according to claim 1, wherein an insulating film is formed, surrounding the surface of a soft magnetic particle.

19. The method of manufacturing soft magnetic articles according to claim 3, wherein an insulating film is formed, surrounding the surface of a soft magnetic particle.

20. The method of manufacturing soft magnetic articles according to claim 5, wherein an insulating film is formed, surrounding the surface of a soft magnetic particle.
